(19) United States
(12) Patent Application Publication
(10) Pub. No.: US 2011/0208810 A1
(43) Pub. Date: Aug. 25, 2011

(54) Optimized Polling in Low Resource Devices

(75) Inventors: Du Li, Palo Alto, CA (US); Umesh Chandra, Sunnyvale, CA (US)

(73) Assignee: NOKIA CORPORATION, Espoo (FI)

(21) Appl. No.: 13/097,186

(22) Filed: Apr. 29, 2011

Related U.S. Application Data
(62) Division of application No. 12/235,744, filed on Sep. 23, 2008.

(51) Int. Cl. G06F 15/16

(52) U.S. Cl. 709/203

(57) ABSTRACT

Methods and systems for optimizing server polling by a mobile client are described, thereby allowing mobile terminals to conserve battery life by more efficiently using resources such as the processor and transceiver in the mobile terminal A broker system may be used to minimize wireless communication traffic used for polling. A broker stub intercepts server polling messages at the client, multiplexes the sever requests together, and forwards the multiplexed message to a broker skeleton that de-multiplexes and forwards the messages as appropriate. Polling may also be dynamically adapted based on user behavior, or a server guard may be used to monitor changes to data, and notify a client to poll its respective server when the server guard detects new or updated data on that server for that client.

This application is a divisional application of Ser. No. 12/235,744, filed Sep. 23, 2008, and having the same title.

### FIELD OF THE INVENTION

The invention relates generally to resource conservation in mobile and low resource devices, such as mobile phones, smartphones, personal digital assistants, ultra-mobile PCs, and the like. More specifically, the invention provides techniques for optimizing polling between a client and its server application to reduce the overhead required to maintain an active and accurate connection between the client and the server.

### BACKGROUND OF THE INVENTION

Intelligent mobile computing devices, such as smartphones and ultra mobile PCs, have become ubiquitous throughout society and throughout the world. Some users primarily use mobile devices occasionally, e.g., in airports or restaurants, when those users do not have access to a more traditional computer that might have dedicated power and a hardwired network connection. Some other users rely on mobile computing devices as their primary data processing devices because those users do not have or even need a more traditional computer for their living or professional needs. Mobile devices use radio technologies for communication and batteries for power. They are becoming sophisticated enough to act as a powerful information terminal, limited only by the duration of the mobile device's battery before the battery must be recharged.

In some environments involving mobile devices, e.g., the Web, a server cannot initiate communication to a client, nor can the server maintain a very long-term connection with a client, out of considerations of security and server scalability. Instead, each client must initiate or establish the connection with the server in order to send data to the server and receive data from the server. In addition, each client must periodically poll the server for new or updated data, preferably frequently, in order to ensure that the client has the most recent information and data. Thus, client-server communication can become a resource hog and a performance bottleneck, causing the mobile device's battery to drain quickly.

### BRIEF SUMMARY OF THE INVENTION

The following presents a simplified summary of the invention in order to provide a basic understanding of various aspects described here. This summary is not an extensive overview of the invention, and is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to more efficiently managing client-server communications between mobile clients and their respective servers from which they obtain data.

A first aspect of the invention provides broker-managed client-server communications between a mobile client (e.g., a mobile terminal) and one or more servers providing data to one or more corresponding client components executing on the mobile client. A broker module (“stub”) executing at the mobile client intercepts server request messages sent by any client components executing on the mobile client. The broker stub multiplexes the server request messages into a broker request message, and transmits the broker request message for receipt by a broker module skeleton executing on a server.

When the broker stub receives a response from the broker skeleton, the broker stub demultiplexes the broker response message into discrete server response messages, each server response message corresponding to a different client component executing on the apparatus.

According to another aspect of the invention, when a broker skeleton (e.g., executing on a web server) receives a multiplexed broker request message from a mobile terminal, the broker skeleton demultiplexes the broker request message into discrete server request messages, and forwards each broker request message to a server identified in each broker request message. When the broker skeleton receives a server response message from each of the identified servers, the skeleton multiplexes the server response messages into a single broker response message, and sends the broker response message to the mobile terminal The single messages transmitted between broker skeleton and broker stub may be sent in multiple packets or bursts, but logically correspond to a single communication.

According to another aspect of the invention, one or more mobile clients executing on a mobile terminal may perform adaptive polling based on user behavior with each application on the mobile client. The mobile terminal may execute a client component to poll at a particular interval to a server providing data for the client, when a user interaction criterion is met. The mobile terminal may execute the client component that polls the server at another interval, different from said first interval, when the user interaction criterion is not met. In one example the user interaction criterion may include the client component being displayed on a display screen of the apparatus. In another example the user interaction criterion may include the client component being displayed on the display screen with a higher level of prominence than a second client component executing on the mobile terminal

According to another aspect of the invention, a server guard module may be used to independently monitor one or more servers for updated data. The server guard module may be executing on a web server or other data processing device having a direct power connection and hardwired network connection. The server guard module may alternatively reside on a mobile terminal, however, if the resources saved and efficiencies gained are greater than when the server guard resides on a device having a constant or direct power source. The server guard module receives a registration message from a client component executing on a mobile terminal Each registration message provides to the server guard information such as the address of the server corresponding to the client component and the query parameters the client component will use to retrieve information from the server. The server guard registers the information in a database. To determine whether each server component has new data intended for its corresponding client component, the server guard either periodically polls each server component according to a predefined schedule or new updates committed to the servers are made aware to the server guard. When a server component has new data intended for its corresponding client component, the server guard notifies the corresponding client component indicating that the server has new data intended for the client component.

According to yet another aspect of the invention, a mobile terminal may be adapted to interact with a server guard. Each client component on the mobile terminal sends a registration message to the server guard. Each registration message provides server component information corresponding to a server providing data to the client component sending the message. The mobile terminal subsequently sends a plurality of heartbeat messages to the server guard module according to a predefined schedule, each message requesting status regarding the availability of new data. The mobile terminal receives a response from the sever guard module, where the response is responsive to one of the heartbeat messages, and indicates the server has new data that the mobile terminal has not yet received.

In one example, the client component on the mobile terminal may subsequently send a polling message to its corresponding server to get the new data, providing any necessary query data (e.g., a current location of the mobile terminal, on which the query might be dependent). Alternatively, when the server does not require query parameters specific to or based on the client component (e.g., the server merely provides Greenwich mean time, regardless of who queries the server), then the response received from the server guard may directly include the new data provided by the server.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network architecture that may be used according to one or more illustrative aspects of the invention.

FIG. 2 illustrates a mobile terminal that may be used according to one or more illustrative aspects of the invention.

FIG. 3 illustrates a data flow between a collaboration client and a collaboration server according to one or more illustrative aspects of the invention.

FIG. 4 illustrates a flowchart for a method of broker-managed server polling according to one or more illustrative aspects of the invention.

FIG. 5 illustrates a flowchart for a method of server guard-managed server polling according to one or more illustrative aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

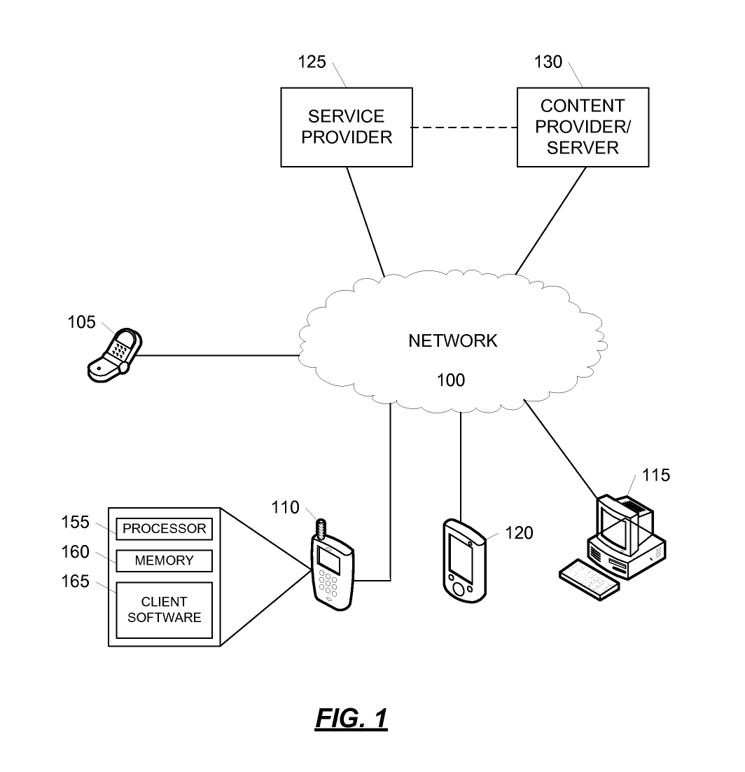

FIG. 1 illustrates an exemplary communication network through which various inventive principles may be practiced. A number of computers and devices including mobile communication devices 105 and 110, personal digital assistant (PDA) 120, personal computer (PC) 115, service provider 125 and content provider 130 may communicate with one another and with other devices through network 100. Network 100 may include wired and wireless connections and network elements, and connections over the network may include permanent or temporary connections. Communication through network 100 is not limited to the illustrated devices and may include additional devices such as a home video storage system, a portable audio/video player, a digital camera/camcorder, a positioning device such as a GPS (Global Positioning System) device or satellite, a mobile television, a set-top box (STB), a digital video recorder, remote control devices and any combination thereof

Although shown as a single network in FIG. 1 for simplicity, network 100 may include multiple networks that are interlinked so as to provide internetworked communications. Such networks may include one or more private or public packet-switched networks (e.g., the Internet), one or more private or public circuit-switched networks (e.g., a public switched telephone network), a cellular network configured to facilitate communications to and from mobile communication devices 105 and 110 (e.g., through use of base stations, mobile switching centers, etc.), a short or medium range wireless communication connection (e.g., Bluetooth®, ultra wideband (UWB), infrared, WiBree, wireless local area network (WLAN) according to one or more versions Institute of Electrical and Electronics Engineers standard no. 802.11), or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access (e.g., a wireless service provider), client software 165 may include instructions for access and communication through the cellular network. Client software 165 may be stored in computer-readable memory 160 such as read only or random access memory in device 110 and may include instructions that cause one or more components (e.g., processor 155, a transceiver, and a display) of device 110 to perform various functions and methods including those described herein.

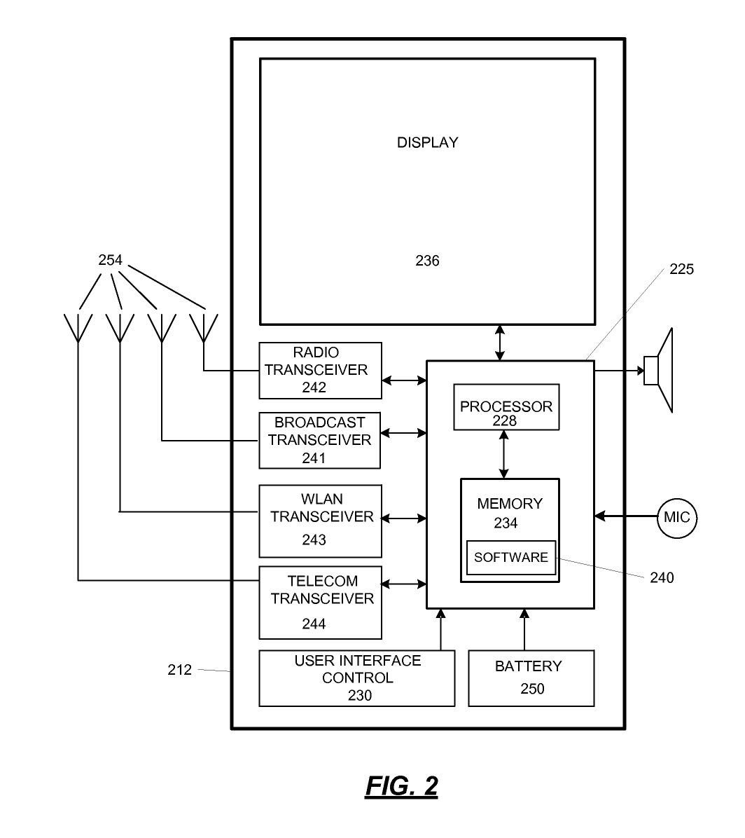

FIG. 2 illustrates a computing device such as mobile device 212 that may be used in network 100 of FIG. 1. Mobile device 212 may include a controller 225 connected to a user interface control 230, display 236 and other elements as illustrated. Controller 225 may include one or more processors 228 and memory 234 storing software 240. Mobile device 212 may also include a battery 250, speaker 252 and antenna 254. User interface control 230 may include controllers or adapters configured to receive input from or provide output to a keypad, touch screen, voice interface (e.g. via microphone 256), function keys, joystick, data glove, mouse and the like.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including EEPROM, flash memory or other memory technology, CD-ROM, DVD or other optical disk storage, magnetic cassettes, magnetic tape, magnetic storage and the like.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, field-programmable gate arrays (FPGAS), controllers, application-specific integrated circuits (ASICS), combinations of hardware/firmware, or other special or general-purpose processing circuitry.

Mobile device 212 or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast transceiver 241. Other digital transmission formats may alternatively be used to deliver content and information of availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components.

Although the above description of FIG. 2 generally relates to a mobile device, other devices or systems may include the same or similar components and perform the same or similar functions and methods. For example, a stationary computer such as PC 115 (FIG. 1) may include the components described above and may be configured to perform the same or similar functions as mobile device 212 and its components.

In Web-based systems, e.g., data communications over the Internet, client-server communications usually follow a request-response pattern where, in response to the client sending an HTTP request to the server, the server sends a response back to the client. The response typically includes data requested by the client. During each request-response cycle, a mobile client needs to establish a TCP connection within its wireless communications network, and then communicate the request/response messages using the TCP connection. Each cycle can take several exchanges of messages, or “round trips,” between the client and the server, and the HTTP request header often takes several hundred (e.g., 600) bytes, even if the application payload only has a few bytes of data. Hence communication latency can be high and link utilization may be low.

The mobility of a device aggravates the problems of HTTP and Web communication because radio technologies such as Wi-Fi and 3G have high communication latencies and low bit rates. Newer wireless data communication technologies present similar problems. The uplink and downlink speeds are typically asymmetric, with the uplink being slower and more energy-consuming After every transmission, the wireless interface may be left in a high power consumption state, and transits into a low power state only after a predefined period of inactivity. Each communication costs CPU cycles, memory, and battery power. If a mobile client has multiple components that need to communicate with a server, the wireless interface is kept busy, the battery drains fast, and the mobile device may become less responsive.

In view of the above, aspects of the invention are directed to improved techniques for client-server interaction using mobile devices when power is a limited resource, i.e., the phone is not plugged in to a power source, but is instead using battery power. The inventive techniques may also be used to conserve power consumption even when the device or apparatus is plugged in, to help with better utilization of network bandwidth by conserving the number of bytes sent, and to better utilizea mobile device's CPU by reducing processing cycles used in communications.

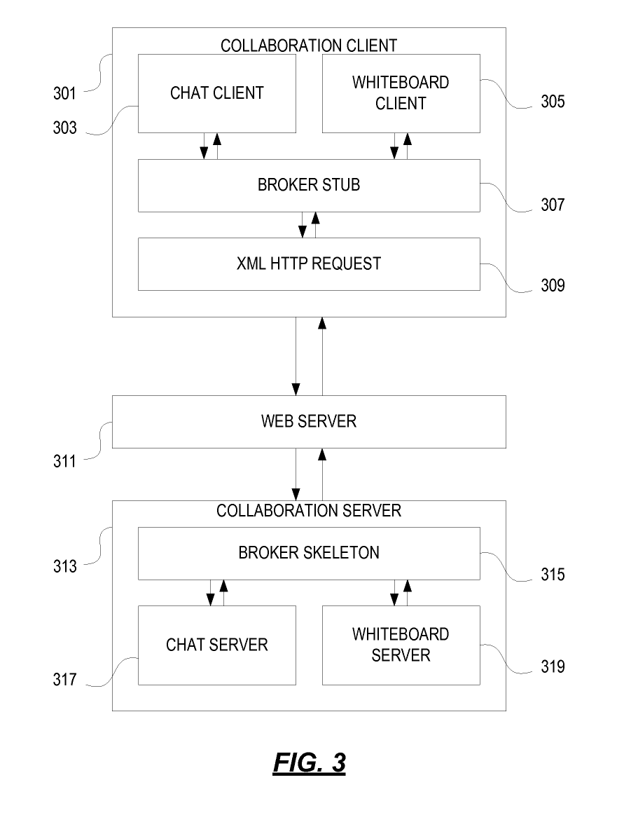

To illustrate various aspects of the invention, the following illustrative scenario is used. With reference back to FIG. 1, devices 110, 120 may be executing client software 165 that provides collaboration services, e.g., a shared whiteboard that all users can draw on, as well as a chat service. With further reference to FIG. 3, client software 165 may be referred to as collaboration client 301. FIG. 3 illustrates a logical data flow diagram between each collaboration client and its applicable servers. With the collaboration client 301, each collaboration service 303, 305 may act as a unique client, in communication with a unique server for that service. For example, the chat feature may be provided in each collaboration client 301 by a chat client software module 303 executing on collaboration client 301 in communication with a chat server software module 317 executing on a collaboration server 313, e.g., a logical server executing on server 130 (FIG. 1). Similarly, the whiteboard feature may be provided in each collaboration client 301 by a whiteboard client software module 305 executing on collaboration client 301 in communication with a whiteboard server software module 319 executing on collaboration server 313, e.g., a logical server executing on server 130 (FIG. 1) distinct from the logical server providing chat features. Additional collaboration services may also be provided, but only two are referenced herein for illustrative purposes.

Each of the chat and whiteboard components has its own user interface on the client side, sometimes provided within a single web page in a browser window. Other user interfaces may alternatively be used. In addition to having unique servers, each component may also have its own database storing data corresponding to the service/feature provided by that component. The application servers 317, 319 may be invoked by a Web server 311, e.g., using Apache, when requests are received from the clients 303, 305. The clients 303, 305 typically poll their respective servers 317, 319 according to a schedule, e.g., every 5 seconds, to retrieve updates available on the server.

According to an aspect of the invention, broker stub 307 and broker skeleton 315 may be used to multiplex and combine server requests into a single message, thereby conserving resources in the mobile client. The broker stub 307 may be coded in Ajax (Asynchronous JavaScript and XML) to provide services that communicate with a server in the background. The broker stub 307 may provide APIs (application programming interfaces) through which the client components may send XMLHttpRequests (XHR) requests to server 313 such that multiple requests can be aggregated and sent as one, and the polling intervals may be dynamically adapted depending on the availability of updates, network conditions, and server workload.

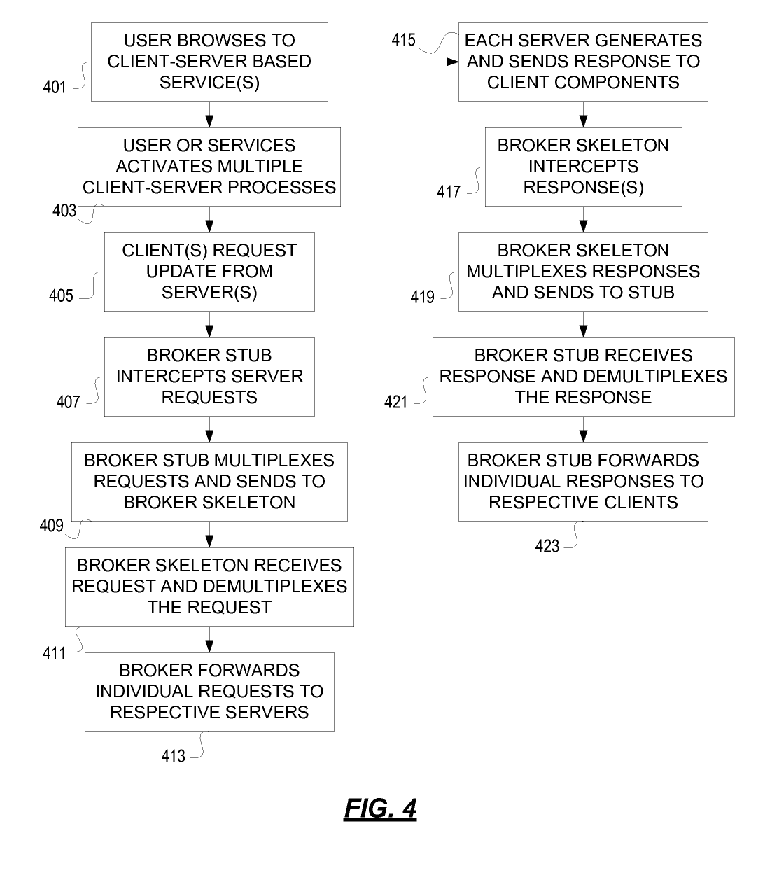

Thus, in the example illustrated in FIG. 3, and with further reference to FIG. 4, a user in step 401 may browse on his or her mobile phone to access a Web-based collaboration service, through which mobile clients 110, 120 communicate with each other via server 313 across a wireless network (e.g., a high-latency network). Throughout the process, broker modules 307, 315 mediate the client-server communication to make the communications more efficient. The broker may include the client side module (stub 307) and the server side module (skeleton 315). Stub 307 may reside in the same Web page as the collaboration client components such as chat 303 and whiteboard 305 and provides APIs for them to communicate with the server 313. Stub 307 may alternatively be independent from client components.

In step 403, a user using a collaboration client 301 activates chat and whiteboard services within the collaboration service. In step 405, each client requests an update from its respective server. Each request may be referred to as a server request message or a component request message. In step 407, broker stub 307 intercepts the multiple server request messages, and in step 409, stub 307 may multiplex requests from those components into one broker request message and send the multiplexed broker request message to broker skeleton 315. In step 411, skeleton 315 intercepts the multiplexed broker request message sent from the stub 307 and demultiplexes the request. In step 413 the skeleton sends or dispatches the demultiplexed requests (the individual component request messages) to their respective original component servers 317, 319.

In step 415 one or more component servers 317, 319 generate a response back to their respective component clients 303, 305. In step 417 broker skeleton 315 intercepts the responses, referred to individually as a server response message or component response message. In step 419 broker skeleton 315 multiplexes the response messages and sends a multiplexed broker response message back to broker stub 307. In step 421 broker stub 307 receives the multiplexed broker response message and demultiplexes the message back into individual component response messages. In step 423 broker stub 307 dispatches or forwards the individual response messagess to their corresponding client components 303, 305.

According to another aspect of the invention, the broker system (e.g., broker skeleton 315 and broker stub 307) may perform adaptive polling. In one embodiment, the stub might not send a periodic polling request until a last connection for that request has completed (or the request has timed out, based on a predefined value), resulting in slowing down a polling task if its interval is too frequent for current network conditions or server workload. The broker stub may also adapt (slow down or speed up) the polling interval of a periodic request according to the availability of updates. The availability of updates may be application-specific insofar as a client component needs to provide feedback to the stub by indicating availability of data via stub APIs.

In one illustrative embodiment, Yahoo! connection manager (YCM) may be used for crossplatform APIs for programming XHR. The main interface may be asyncRequest(method, url, callback, data), which sends an asynchronous request to a server. Among the four arguments, method is an HTTP method such as GET and POST; url is the address of the target Web server; callback is the object for handling the server response; data holds the data to be sent in a POST request. The callback object may provide the following three members: success is the function called to process the server response that is returned successfully; failure is the function to handle a problematic response, e.g., communication failure or server error; argument is any object containing data for the success and failure handlers to process the server response.

The APIs may leverage YCM for underlying XHR communications by distinguishing the following four types of XHR tasks: one-time polling to query the server, e.g., to load shared data when a component is initialized, periodic polling to periodically query the server for new updates to some shared data, one-time updating to notify the server of local state changes to some shared data, and periodic updating to periodically send updates of some shared data to the server.

Every task may define a unique id, a method to get its url, and a callback object. An updating task additionally defines a method to get the data to be sent. A periodic task also may define an interval to specify the frequency at which the request is sent. In some embodiments, periodic updating may be used, e.g., when Web service APIs support input sources such as mic, camera, and GPS, which may generate periodic updates.

One-time polling and updating tasks may be sent in specific components by calling Ajax broker methods, send_polling(task) and send_updating(task), respectively, where object task is defined as above. A periodic polling task is sent by the broker stub after the component registers it by calling Ajax broker method register_polling(task).

According to an aspect of the invention, the broker stub 307 may administer periodic polling requests by multiplexing requests and adapting the request intervals. In an embodiment, the broker system might only multiplex periodic polling requests while sending one-time polling and updating requests as individual messages. Multiplexing requests inevitably comes with more runtime overhead. Because one-time requests are usually triggered by user interaction with component UIs, the user often expects to see some UI feedback within a short time. Hence the system may send a one-time request immediately as soon as the interaction occurs so that the request can reach the server and get a response back with minimum delay. On the other hand, periodic polling tasks may be background activities used to pull remote updates and more tolerant of delays. Hence the system might only multiplex periodic polling tasks.

In the broker stub 307, a meta system timer regularly sends out periodic requests. Preferably, the timer interval (denoted by system parameter meta_interval) should be the greatest common divisor (gcd) of the intervals of all periodic requests. In practice, a value such as 1,000 ms (or any other value) may be used. Periodic polling tasks may be registered in an internal queue, polling_tasks. Each task t may use parameter t.interval to denote its interval, parameter t.last_time to denote the last time it was sent (by itself or multiplexed), and parameter t.connection to denote the connection by which it was sent.

The meta timer may scan polling tasks for every task t that satisfies the following two conditions simultaneously: (1) now−t.last time>=t.interval, where now is current time, and (2) t.connection is not in progress. A connection is in progress if the request has been sent but not completed either as a success or a failure. URLs of those qualified tasks are sent in one request to the broker skeleton via the YCM asyncRequest method. Meanwhile, their last time parameters are set to current time now at which they are sent.

The meta timer may have its own callback object for handling responses from the server. The argument parameter of its callback object tracks which polling tasks have been multiplexed and sent. When a multiplexed response is received from the skeleton, the meta timer's response handler parses the message, finds responses to individual polling tasks, and dispatches them to their response handlers, which in turn parse the data and reflect the responses on their component UIs.

Multiplexing as described herein saves on number of bytes sent and power consumption. However, it may take longer time for an individual task to receive a response from the server than when not multiplexed. Even though a slightly larger multiplexing payload might not increase the transmission time much, it takes the server longer to process multiple requests than one. As a result, one-time requests might not be multiplexed, as explained above.

Because a polling request, multiplexed or not, may still waste resources if there is no update on the server, another embodiment of the invention may use an alternative form of adaptive polling. The second condition in multiplexing, i.e., the one by which the meta timer decides whether a connection is in progress, already demonstrates some adaptive behavior. After a request is initiated, the resources are not released until a response is received or a time out event happens. The response may be delayed for many reasons. For example, the web browser has reached the maximum number of allowed active connections established between this client and the server; the network is congested; or the server is saturated, to name a few. Under those circumstances, deferring the request to the next round may be beneficial to the performance of the system as a whole.

Additionally, the stub may provide a method for a component to provide a positive or negative feedback to the stub upon receipt of a server response: polling_feedback(id, new_data), where id is the id of the registered periodic polling task and new_data indicates availability of updates in the response. A positive feedback asks the stub to speed up the polling task by decreasing its interval, and a negative feedback asks the stub to slow down the task by increasing its interval. How fast to speed up or slow down, however, may depend on an adaptive method chosen for the task.

That is, each periodic polling task may have a parameter, adaptive_method, that indicates to the stub how to adapt its interval when a feedback is given. An adaptive method may use two parameters including min_interval and max_interval that define the range within which the interval of a task may be adapted. A periodic polling task may start with an initial interval and the interval is adapted over time. By default, a hybrid adaptive method may be used, in which the interval is set to min_interval upon a positive feedback and decreased by a constant or variable amount (meta_interval) upon receipt of negative feedback. In one illustrative embodiment, the hybrid method may use a binary speedup, which is the most aggressive, and a linear slowdown, which is the most conservative. In this manner, as soon as one update is received, multiple polling requests may be sent in a row, expecting that several new updates are likely to follow in response to the first one in a collaborative system.

The min_interval parameter may take the same value as meta interval, which is the highest frequency at which the stub sends periodic requests. The meta_interval may be dependent on the average round-trip communication time between the client and the server. For simplicity, however, in a cellular network environment, one embodiment may set the meta_interval at 1,000 ms. The max_interval parameter, however, preferably reflects users' tolerable feedthrough delay, e.g., the time it takes for an update made by one user to reach another user. Different types of collaboration tasks, ranging from realtime to non-realtime tasks, may have different tolerable feedthrough delays. For supporting near-realtime collaboration, for example, the default component-level max_interval may be 10,000 ms. Thus, the system may provide set_max_interval(b) methods that allow the user to specify lowest polling frequencies at the stub level (applying to all components) and at the component level (only applying to that component). The effective max_interval of each component is then the minimum of these two bounds when its polling interval is adapted. Adaptive polling thereby also eases the problem of providing an “optimal” interval for a periodic polling task, because the user only needs to specify a range instead of a specific value. If a component is less tolerant of feedthrough delays, one can specify a smaller maximum, e.g., 3,000 ms.

In the above illustrative example, upon receipt of a multiplexed request from the broker stub 307, the broker skeleton 315 parses the request and extracts the original polling requests. Then the requests are served and responses multiplexed to send back to the stub in one message.

To serve those requests, the broker skeleton might either forward their URLs to their original component servers, or make function calls to the server functions directly. Either way, those operations can be executed synchronously in serial or asynchronously in parallel. Hence in total there are four possible execution strategies, namely, call-serial (function calls in serial), call-async (calls in parallel), url-serial (forwarding URLs in serial), and url-async (forwarding URLs in parallel).

Based on the above, one illustrative system might include policies and parameters that affect performance, as illustrated in Table 1.

TABLE 1

| Parameter | Description |
|---|---|
| Meta_interval | how frequent the meta timer should |
| | tick to multiplex and send periodic polling requests |
| Max_interval | the maximum interval at the stub level, or the lowest |
| | frequencies the stub should send periodic polling requests |
| Multiplexing | whether periodic polling requests |
| | should be multiplexed; if no multiplexing, all requests are |
| | sent individually to their original component servers |
| Adaptive | whether the periodic polling tasks' intervals |
| | should be adapted; if non-adaptive, all pollings are sent |
| | by their initial intervals; if adaptive, which |
| | adaptive_method to use, and which min_interval |
| | and max_interval parameters to use for setting the range |
| Exec_mode | which execution strategy |
| | (e.g., call-serial, call-async, url-serial, url-async) should |
| | be used in the skeleton to serve the multiplexed requests |

By default, the meta interval may be set to 1,000 ms; the stub-level max interval may be 10,000 ms; the multiplexing and adaptive parameters may be set to “true”; the adaptive_method of all periodic polling tasks may be defaulted to the above-explained “Hybrid” method with polling interval ranging between 1,000 ms and 10,000 ms. The server exec mode may be defaulted to “call-serial”.

Various modifications and alternatives may optionally be made to the broker system described above. According to an aspect of the invention, the broker may perform an alternative form of adaptive polling based on user behavior. More specifically, the polling intervals may be dynamically adapted based on user behavior while using the client device. For example, in the collaboration example described above, a mobile device's screen is often so small that not all components can be displayed at the same time or they cannot be displayed with equal size. Thus, when a component becomes invisible or less obvious to the user, the polling interval of that component may be adapted so that component polls its corresponding server less frequently. Conversely, when a component becomes visible or draws more attention from the user, that component's polling interval may be adapted so that it polls more frequently. Adaptive polling based on user behavior may be performed either by the component client itself or by a client proxy, e.g., broker system 307, 315. Thus, adaptation of polling intervals may be based on user behavior, e.g., making a component more visible or less visible. For example, when the user resizes a user interface (UI) of a component client, or modifies the visibility or other visual/audio attributes of the UI, the polling interval of that component may be automatically adjusted accordingly.

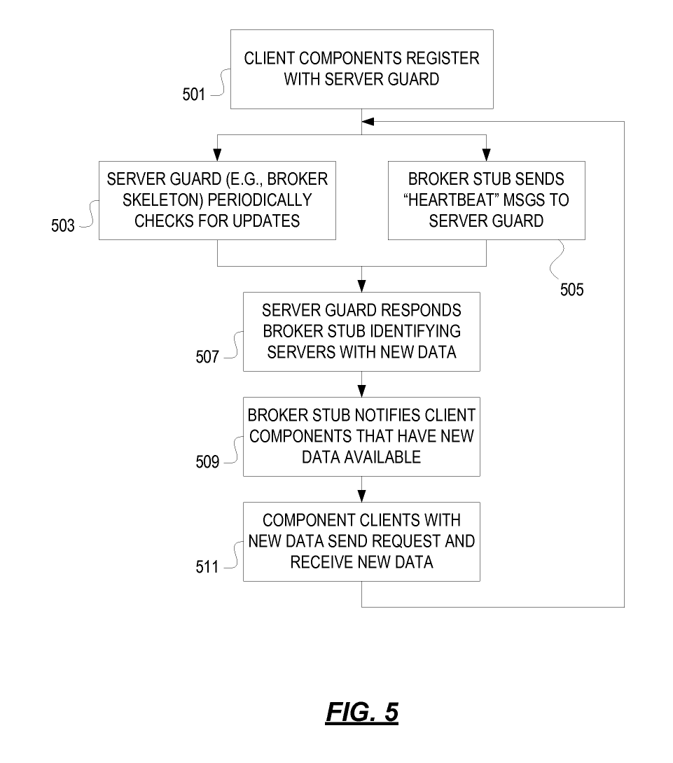

With reference to FIG. 5, another aspect of the invention, using a server guard may eliminate blind periodic polling. There may be a “guard” service on the server side, between the Web server and the component server(s). The server guard may be the same as or different from broker skeleton 315. In step 501, a component client registers its URL with the server guard, distinguishing an invariant part and a variant part of the URL. For example, in URL “http://web.address.com/server_name?a=1&b=2”, the invariant part is “http://web.address.com/servername” and the variant part is “a=1&b=2”. The invariant part typically points to the component server, while the variant part may include any query parameters. Each client component may send a registration message to the server guard, providing the invariant and variant URL information.

Steps 503 and 505 may occur simultaneously or at least in parallel to each other. Stated another way, neither of steps 503 and 505 are dependent on each other occurring before the other step can occur. In step 503, the server guard determines whether there have been any updates to the data provided by each server. This can achieve in several ways, e.g., by the server guard periodically polling the servers for new data, or by the servers proactively notifying the server guard of any new data. In step 505 the broker stub 307 is concurrently or in parallel sending periodic “heartbeat” messages to the server guard, in order to find out which servers have new or updated data. The heartbeat requests preferably do not include any specific polling request, but rather include a simple query to find out which servers have updated data or have new data for its corresponding component client.

In step 507 the server guard responds to the broker stub, providing an indication of which servers have posted new/updated data. In step 509 the broker stub sends a message to those client components for which there is new/updated data, indicating the availability of the new/updated data. Finally, in step 511, any component client that has been informed regarding the availability of new data sends a polling request to its respective server to obtain the new data, using the variant parameters specific to that component client. In cases where there is no variant portion of the query, e.g., the same query is posed on the database all the time, then the server guard may optionally retrieve the data from the database and provide the data with the response to the heartbeat message when there is an update for the corresponding component client, thereby expediting the update process for that component client.

According to an embodiment of the invention using the server guard described above, the server guard may create and use a small database table, which optionally may be resident in the main memory of the server guard for fast access. Subsequently, when any updating request from a component client X1 potentially changes the response to the polling request from a component client X2, the small table is updated to indicate the availability of updates. For example, a first user using mobile terminal 110 (FIG. 1) and running chat client X1, might be communicating with a second user using mobile terminal 120 and running chat client X2. The first user typing in some text in the chat client will result in an update being posted for chat client X2 so that the second user can view the chat text input by the first user. Thus, when a heartbeat comes from the client proxy corresponding to the second user's component client X2, the server guard indicates availability of updates in its response to the heartbeat request. If X2's URL has no variant parameters, the updates may be retrieved by the server guard executing the chat client's registered URL and piggy-backing the response on the response to the heartbeat. Otherwise the server guard responds to X2's heartbeat request by instructing component client X2 to poll its respective server using its full URL (with invariant and variant portions).

According to an illustrative embodiment, the database table may include the following two fields: (component_id, last_update_timestamp). Then, when an update is made to the component database (or anywhere that may affect the response to component X2's polling request), the entry for component X2 is updated with the server time (say T1) at which the update occurs.

The heartbeat message from X2's client proxy carries a timestamp (say T2) which is the timestamp of the most recent update that X2 has received. When receiving the heartbeat, the guard compares T1 and T2, and if T1>T2 then an indication regarding the availability of updates is piggy-backed on the response to the heartbeat. The client proxy (broker stub) in turn instructs X2 to send a polling request. On the other hand, if there is no variant part in the query, the new data is directly retrieved by the server guard and piggybacked in its response to the heartbeat message.

Aspects of the invention as described above reduce the number of polling requests and the total of number of bytes sent from a mobile client to its corresponding server. In addition, aspects of the invention described above conserve client device CPU processing, memory, bit rates, and battery life. Aspects of the invention also reduce the server workload, and improve the performance of a variety of mobile Internet services.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a processor configured to control some operations of the apparatus; and
memory storing computer readable instructions that, when executed by the processor, configure the apparatus to perform server polling by:
executing a client component to poll a server at a first rate when a user interaction criterion is met, wherein said server provides data for the client component; and
executing the client component to poll the server at a second rate, different from said first rate, when the user interaction criterion is not met.

2. The apparatus of claim 1, wherein the user interaction criterion comprises the client component being displayed on a display screen of the apparatus.

3. The apparatus of claim 1, wherein the user interaction criterion comprises the client component being displayed on the display screen with a higher level of prominence than a second client component executing on the apparatus.

4. The apparatus of claim 1, wherein the first rate is faster than the second rate.

5. The apparatus of claim 1, comprising a mobile telephone.

6. A method comprising:
executing a client component;
the client component polling a server at a first rate when a user interaction criterion is met, wherein said server provides data for the client component; and
the client component polling the server at a second rate, different from said first rate, when the user interaction criterion is not met.

7. The method of claim 6, wherein the user interaction criterion comprise the client component being displayed on a user interface.

8. The method of claim 6, further comprising executing a second client component, and wherein the user interaction criterion comprises the client component being displayed on a user interface with a higher level of prominence that the second client component.

9. The method of claim 6, wherein the first rate is faster than the second rate.

10. The method of claim 6, wherein executing a client component comprises executing the client component on a device comprising a mobile telephone.

11. The method of claim 7, further comprising displaying the user interface on a display screen of the mobile telephone.

12. One or more computer readable media storing computer readable instructions that, when executed, perform server polling by:
executing a client component to poll a server at a first rate when a user interaction criterion is met, wherein said server provides data for the client component; and
executing the client component to poll the server at a second rate, different from said first rate, when the user interaction criterion is not met.

13. The computer readable media of claim 12, wherein the user interaction criterion comprises the client component being displayed on a display screen of the apparatus.

14. The computer readable media of claim 12, wherein the user interaction criterion comprises the client component being displayed on the display screen with a higher level of prominence than a second client component executing on the apparatus.

15. The computer readable media of claim 12, wherein the first rate is faster than the second rate.

16. An apparatus, comprising:
a processor configured to control some operations of the apparatus; and
memory storing computer readable instructions that, when executed by the processor, configure the apparatus to act as a server guard by:
receiving a registration message , said registration message providing server information for a server component corresponding to a client component;
registering the server information in a database;
polling the server component according to a predefined schedule to determine whether the server component has new data intended for the client component; and
when the server component has new data intended for the client component, sending a message addressed to the client component indicating that the server component has new data intended for the client component.

17. The apparatus of claim 16, wherein the server information comprises invariant data that is generic to the server component, and comprises variant data that is based on the client component.

18. The apparatus of claim 16, wherein the server information comprises only invariant data that is generic to the server, and wherein the apparatus is further configured to:
when the server component has new data intended for the client component, sending a query to the server component, said query comprising the invariant data; and
forward in the message to the client component, any data received from the server component in response to the query.

19. The apparatus of claim 16, wherein the predefined schedule is based on heartbeat messages received from the client component.

20. One or more computer readable media storing computer readable instructions that, when executed, perform:
receiving a registration message , said registration message providing server information for a server component corresponding to a client component;
registering the server information in a database;
polling the server component according to a predefined schedule to determine whether the server component has new data intended for the client component; and
when the server component has new data intended for the client component, sending a message addressed to the client component indicating that the server component has new data intended for the client component.

21. The computer readable media of claim 20, wherein the server information comprises invariant data that is generic to the server component, and comprises variant data that is based on the client component.

22. The computer readable media of claim 20, wherein the server information comprises only invariant data that is generic to the server, and wherein the apparatus is further configured to:
when the server component has new data intended for the client component, sending a query to the server component, said query comprising the invariant data; and
forward in the message to the client component, any data received from the server component in response to the query.

23. The computer readable media of claim 20, wherein the predefined schedule is based on heartbeat messages received from the client component.

24. A method comprising:
receiving a registration message , said registration message providing server information for a server component corresponding to a client component;
registering the server information in a database;
polling the server component according to a predefined schedule to determine whether the server component has new data intended for the client component; and
when the server component has new data intended for the client component, sending a message addressed to the client component indicating that the server component has new data intended for the client component.

25. The method of claim 24, wherein the server information comprises invariant data that is generic to the server component, and comprises variant data that is based on the client component.

26. The method of claim 24, wherein the server information comprises only invariant data that is generic to the server, and wherein the apparatus is further configured to:
when the server component has new data intended for the client component, sending a query to the server component, said query comprising the invariant data; and
forward in the message to the client component, any data received from the server component in response to the query.

27. The method of claim 24, wherein the predefined schedule is based on heartbeat messages received from the client component.

28. An apparatus comprising:
a processor; and
memory storing computer executable instructions that, when executed by the processor, configure the apparatus to poll a server by:
wirelessly sending a registration message addressed to a server guard module, wherein said registration message comprises server information corresponding to a server component providing data to a client component executing on the apparatus;
sending a plurality of heartbeat messages addressed to the server guard module according to a predefined schedule; and
receiving a response to one of the heartbeat messages, said response indicating the server component has new data that the apparatus has not yet received.

29. The apparatus of claim 28, wherein the server information comprises invariant data generic to the server component and variant data based on the apparatus, and
wherein the apparatus is further configured to poll the server component by, based on receiving the response, sending a polling message to the server component, said polling message based on both the invariant and variant data.

30. The apparatus of claim 28, wherein the server information comprises only invariant data generic to the server component, and
wherein the response received from the server guard module comprises data provided by the server component in response to a query based on the server information.

31. The apparatus of claim 28, wherein receiving a response comprises receiving a response from the server guard module.

32. A method comprising:
wirelessly sending a registration message addressed to a server guard module, wherein said registration message comprises server information corresponding to a server component providing data to a client component;
sending according to a predefined schedule a plurality of heartbeat messages addressed to the server guard module; and
receiving a response to one of the heartbeat messages, said response indicating the server component has new data that the client component has not yet received.

33. The method of claim 32, wherein the server information comprises invariant data generic to the server component and variant data based on the apparatus, said method further comprising, based on receiving the response, sending a polling message to the server component, said polling message based on both the invariant and variant data.

34. The method of claim 32, wherein the server information comprises only invariant data generic to the server component, and
wherein the response received from the server guard module comprises data provided by the server component in response to a query based on the server information.

35. The method of claim 32, wherein receiving the response comprises receiving the response from the server guard module.

36. One or more computer readable media storing computer executable instructions that, when executed, perform:
wirelessly sending a registration message addressed to a server guard module, wherein said registration message comprises server information corresponding to a server component providing data to a client component executing on the apparatus;
sending a plurality of heartbeat messages addressed to the server guard module according to a predefined schedule; and
receiving a response to one of the heartbeat messages, said response indicating the server component has new data that the apparatus has not yet received.

37. The computer readable media of claim 36, wherein the server information comprises invariant data generic to the server component and variant data based on the apparatus, and
wherein the apparatus is further configured to poll the server component by, based on receiving the response, sending a polling message to the server component, said polling message based on both the invariant and variant data.

38. The computer readable media of claim 36, wherein the server information comprises only invariant data generic to the server component, and
wherein the response received from the server guard module comprises data provided by the server component in response to a query based on the server information.

39. The computer readable media of claim 36, wherein receiving a response comprises receiving a response from the server guard module.
